(19) United States
(12) Patent Application Publication
(10) Pub. No.: US 2008/0168715 A1
(43) Pub. Date: Jul. 17, 2008

(54) SASH LIFTER FOR CASEMENT WINDOWS

(76) Inventor: John E. Titus, Lonsdale, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/015,266

(22) Filed: Jan. 16, 2008

Related U.S. Application Data
(60) Provisional application No. 60/885,127, filed on Jan. 16, 2007.

(51) Int. Cl. E05F 7/02

(52) U.S. Cl. 49/353; 49/360; 49/375

(57) ABSTRACT

A sash lifter for positioning a window sash within a window frame of a casement window includes a body portion presenting a sash positioning surface. As the window sash is rotated within the window frame about an axis of rotation defined by at least one hinge assembly, the window sash encounters the sash lifter and rides along the sash positioning surface until it is properly situated within the window frame. The sash lifter may include a barrier structure extending transverse to the axis of rotation to facilitate positioning of the sash lifter within a track of the hinge assembly. The sash lifter may also include a tail structure extending outward from the body portion for increased forced-entry resistance.

### RELATED APPLICATIONS

The present application claims the benefit of U.S. Provisional Application No. 60/885,127, entitled SASH LIFTER FOR CASEMENT WINDOWS, filed Jan. 16, 2007, which is hereby fully incorporated herein by reference in its entirety.

### FIELD OF THE INVENTION

The present invention relates generally to an improved casement window, and more specifically to a casement window sash lifter having structure to counteract sash sag.

### BACKGROUND OF THE INVENTION

Casement window assemblies are well known in the art and described in, for example, U.S. Pat. No. 3,845,585 to Cecil, entitled “Casement Window,” and U.S. Pat. No. 4,254,583 to Smits, et al., entitled “Window Unit,” which are both hereby incorporated by reference herein. In general, a casement window includes a window sash comprised of a sheet of glass surrounded by wood, vinyl, or metal structure. The window sash of a casement window is generally operably disposed in the window frame with an upper hinge assembly and a lower hinge assembly. Typically, a crank mechanism is coupled to the sash for selectively opening and closing the window. To ensure proper performance of the casement window, the window sash should be squarely aligned within the window frame.

A common drawback of casement windows is sash sag, which occurs when the sash portion of the window becomes out-of-square with the window frame. Sash sag can result from a number of factors, including movement during installation, improper hinge positioning by the window manufacturer, settling of the building, warpage of the window, the effect of gravity upon the sash in the open position, or fatigue or contact with the window frame as the window is opened and closed.

A window with sash sag will not properly seal and puts undue strain on the sealing elements surrounding the sealed glass assembly, leading to failure. As a result the window may be less effective in inhibiting infiltration of air and moisture into the structure, thereby increasing energy costs for heating and cooling of the building. Moreover, the improper seal may allow moisture into the window frame itself and surrounding structure, which can lead to deterioration of the window frame and the structure.

In some circumstances, sash sag may be severe enough such that the frame interferes with the ability of the window sash to be completely closed. This interference increases force and torque throughout the entire casement window assembly and may make it more difficult for a user to open and close the window. In some cases, the sash sag may result in premature failure or even prevent the window from closing altogether.

To inhibit sash sag, it is important that the window sash remain square within the window frame, including during transport of the window assembly. To that end, shipping blocks are commonly used to stabilize the window sash within the window frame during shipment of the window assembly. These shipping blocks are typically designed to be removed from the window assembly upon installation. The shipping blocks are often stapled to the window assembly in locations where they are not readily seen. As a result, they are sometimes left in place after installation and as the window is operated and sash sag occurs over time, they interfere with opening and closing of the window and can cause damage to the window frame and sash. Eventually, permanent damage to the window assembly can result due to scraping of the block against the window frame and twisting of the window sash about its hinges.

One solution to correct sash sag is by realigning the hinge so that the window sash sits properly within the window frame. However, on some windows this requires disassembly of the hinge, which is labor intensive and costly. Alternatively, sash sag may be corrected with an adjustable hinge mechanism. An example of an adjustable mechanism designed to alleviate sash sag is disclosed in U.S. Pat. No. Re. 34,657 ('657 reissue) to LaSee, entitled “Cam Adjustment Device For Casement Window Unit,” which is hereby incorporated by reference herein. More specifically, the '657 reissue discloses an index cam comprising a series of serrations that can engage a plurality of serrations on the track of the hinge assembly, which permits the cam to move relative to the track and facilitates adjustment of a link connected to a casement window sash. A drawback to this mechanism, however, is that the engagement of the serrations on the cam with corresponding serrations on the track only permits predetermined, or defined, movements of the cam within the track. Additionally, the detailed structure of the cam and the track can increase manufacturing costs and make it more difficult to adjust the window sash once the hinge assembly has been installed.

Another drawback of casement windows is that they are prone to forced entry. Typically a locking mechanism is provided on the vertical frame member opposite the hinge side of the window. These locking mechanisms generally are selectively engagable with the window sash to latch the window sash in place at one or more points when the sash is closed. Typically, however, a gap is provided between the window sash and the window frame at the top and bottom of the window to allow for some misalignment of the sash. This gap can sometimes be sufficiently large so to allow the sash to be pried vertically within the frame a sufficient distance so that the locking mechanism is disengaged. In this way, an intruder can defeat the locking mechanism to gain entry to the structure through the window.

Therefore, there is a need in the window industry for an apparatus and method for inhibiting sash sag that is passive in operation and does not require the disassembly of the casement window, or manual adjustment by the user to counteract and/or eliminate sash sag, and that can be manufactured at a lower cost relative to existing hinge assemblies used to reduce sash sag. Moreover, apparatuses and methods of inhibiting forced entry and damage during shipping are also needed to address the drawbacks identified above.

### SUMMARY OF THE INVENTION

The sash lifter of the present disclosure addresses the above-mentioned needs by providing an apparatus that is a single passive piece without any moving parts. The sash lifter assembly of the present invention can be mounted on a track structure of a hinge assembly, buttressing the sash to counteract and/or eliminate sash sag without the disassembly of the casement window assembly or manual adjustment by the user. Sash lifters according to an embodiment of the invention may also be positioned at other locations on the frame in addition to or as an alternative to a sash lifter on the hinge track.

In a first embodiment, the sash lifter may include a base and an arcuate top portion, or positioning surface. The sash lifter further includes an aperture therethrough and a notch in the arcuate positioning. In operation, the sash rides up on the arcuate positioning surface as the sash is rotated into a closed position, thereby smoothly lifting the sash into position in the frame as the sash is closed.

In another embodiment, a protrusion may extend from the bottom of the sash lifter transverse to a fastener aperture. When mounted on a track structure of a hinge assembly, the protrusion fits into a correspondingly sized aperture in the hinge track to enable precise positioning of the sash lifter on the track. The protrusion may be made sufficiently thin or made from a crushable or frangible material so as to be crushed or fractured from the sash lifter when the sash lifter is fastened to a surface without an aperture, thereby enabling level and secure attachment of the sash lift to nearly any surface.

In another embodiment, the sash lifters have a barrier structure extending outward that may be placed on the top and bottom members of the window frame proximate the side opposite the hinge. The barrier structure of the sash lifter fits into the gap between the sash and frame to inhibit vertical shifting of the sash within the frame, thereby reducing the ability of an intruder to disengage the lock mechanism of the window to gain unauthorized entry to the structure.

In yet another embodiment, the sash lifter may be used as a shipping block and be left in place after window installation to serve as an FER block and/or sash lifter.

Accordingly, in some embodiments, a casement window system according to the present invention comprises a window frame, a window sash, a hinge assembly coupling the window sash to the window frame, and a sash lifter. The hinge assembly includes a track portion on the window frame. The track portion defines at least one aperture. The sash lifter comprises a body with a first side presenting a sash positioning surface and a generally opposing second side presenting a frame mounting surface. The body defines an opening for receiving a fastening member. The sash lifter also comprises a protrusion extending outwardly from the second side. The protrusion mates with the aperture on the track portion of the hinge assembly to locate the sash lifter on the track portion.

In a further embodiment, a window system according to the present invention comprises a window frame, a window sash in the window frame defining a gap therebetween, a hinge assembly coupling the window sash to the window frame, and a sash lifter on the window frame. The sash lifter comprises a body and a tail portion. The body presents a sash positioning surface and defines an opening for receiving a fastening member to fasten the sash lifter to the frame. The tail portion extends into the gap defined between the window frame and the window sash.

In other embodiments, the body may present a distal end and a proximal end, the sash positioning surface sloping generally upward from the distal end to the proximal end. The sash positioning surface may define a substantially arcuate region between the distal and proximal sash ends. Alternatively, the sash positioning surface may define a substantially planar region between the distal and proximal ends. The sash positioning surface may also define both a substantially arcuate region and substantially planar region between the distal and proximal ends, the substantially arcuate region being located generally distally and the substantially planar region being located generally proximally. The sash lifter may substantially prevent lateral movement of the window sash within the window frame. The body of the sash lifter may further define a notch at the distal end. The protrusion may be snap-fit into the aperture. The aperture may be elongate and the protrusion may be slidable in the aperture. The tail portion may inhibit vertical shifting of the window sash within the window frame.

In a further embodiment, a casement window system according to the present invention comprises a window frame, a window sash, a hinge assembly coupling the window sash to the window frame, and a sash lifter. The hinge assembly includes a track portion on the window frame. The sash lifter comprises a body and a means for locating the sash lifter on the window frame. The body has a first side presenting a sash positioning surface and a generally opposing second side presenting a frame mounting surface. The body defines an opening for receiving a fastening member.

In other embodiments, the means for locating the sash lifter on the window may comprise a protrusion extending outwardly from the frame mounting surface. The window frame may be made from wood, the protrusion being adapted to facilitate penetration of the wood. The window frame may define a groove and may be made from a non-wood material, the protrusion being adapted to collapse into the groove. The track portion of the hinge assembly may define an aperture and the protrusion may mate with the aperture to located the sash lifter on the track portion.

### BRIEF DESCRIPTION OF THE FIGURES

The embodiments of the present invention may be more completely understood in consideration of the following detailed description of various embodiments in connection with the accompanying drawings, in which:

FIG. 1 is a perspective view of a casement window assembly according to an embodiment of the present invention in an open position;

FIG. 2 is an outside elevation view of a casement window assembly according to an embodiment of the present invention in a closed position;

FIG. 3 is a top plan view of a track structure of a hinge assembly according to an embodiment of the present invention;

FIG. 4 is a top plan view of a track structure of a hinge assembly according to an embodiment of the present invention;

FIG. 5 is a top plan view of a track structure of a hinge assembly according to an embodiment of the present invention;

FIG. 6 is a top view of an embodiment of a sash lifter according to an embodiment of the present invention;

FIG. 7 is a side perspective view of an embodiment of a sash lifter according to an embodiment the present invention;

FIG. 8 is a side plan view of a sash lifter according to an embodiment of the present invention mounted on a track;

FIG. 9 is a side plan view of a sash lifter according to an embodiment of the present invention mounted on a track;

FIG. 10 is a top view of a sash lifter according to an embodiment of the present invention;

FIG. 11 is a fragmentary side view of a window frame and a window sash with a sash lifter according to an embodiment of the present invention the sash being lifted into position with the sash lifter; and

FIG. 12 is a fragmentary side view of a window frame and a window sash with a sash lifter according to an embodiment of the present invention with the sash lifter positioned as a forced entry resistance block; and

While the present invention is amendable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE INVENTION

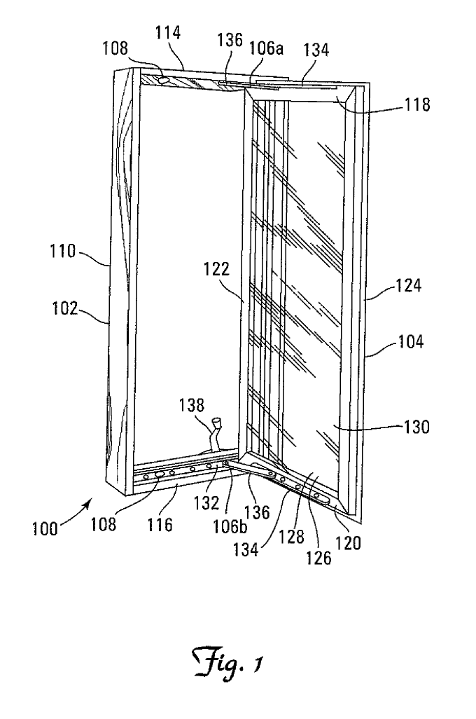

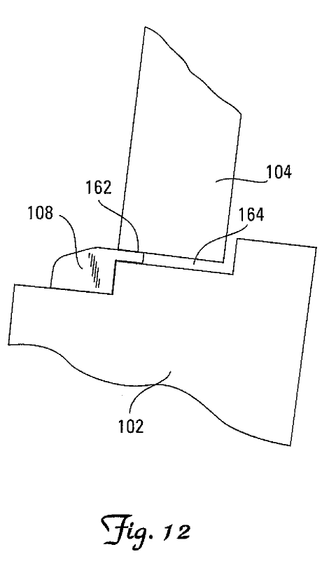

Referring to FIG. 1, a window assembly is depicted generally with reference numeral 101. Although window assembly 100 and the components of window assembly 100 depicted in FIGS. 1-12 are adapted for use as casement window, one skilled in the art will readily recognize that window assembly 100 may include any number of other configurations. As such, the embodiments of the present invention depicted in FIGS. 1-12 are merely illustrative of one such window assembly 100. Other window assemblies 100 may also incorporate alternative embodiments of the present invention.

Window assembly 100 generally includes window frame 102, window sash 104, hinge assembly 106, and sash lifter 108. Although sash lifter 108 can be used for a variety of purposes and in a number of different ways, sash lifter 108 is generally mounted to window frame 102 or hinge assembly 106 to facilitate transportation of window assembly 100, alleviate sash sag, and/or provide enhance forced-entry resistance (FER).

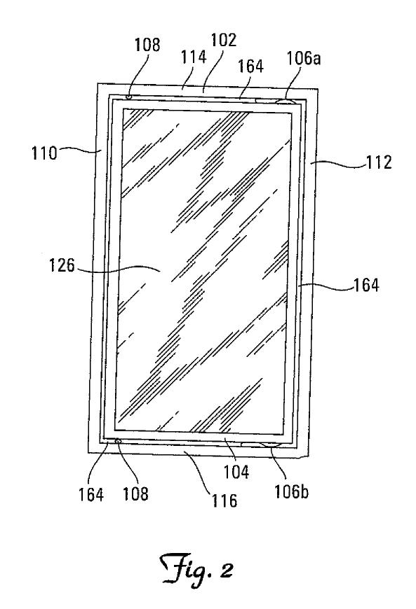

Referring to FIGS. 1-2, a conventional residential casement window assembly 100 generally includes a window frame 102 having two vertical frame members 110, 112, an upper horizontal frame member 114 and a lower horizontal frame member 116. Window assembly 100 also comprises a window sash 104. Window sash 104 generally includes upper horizontal member 118, lower horizontal member 120, vertical frame members 122, 124, and glass assembly 126, which may include one or more panes 128, 130. In general, window sash 104 is sized to closely fit within window frame 102 in order to seal out moisture and maintain the environment within the structure.

Window assembly 100 further generally includes hinge assembly 20. In an example embodiment, window assembly 106 includes upper hinge assembly 106a lower hinge assembly 106b. Hinge assemblies 106 generally which facilitate hingably mounting window sash 104 in window frame 102. Each hinge assembly 106 generally include track 132 mounted to the window frame 102, sash arm 134 coupled to the window sash 104, support arm 136 mounted on a first end to track 132 and to the sash arm 134 at the opposing end, and crank mechanism 138. Sash 104 is operated by rotating crank mechanism 138 so that window sash 104 pivots about the vertical axis. Further general details of casement window hinge assemblies are included in U.S. patent application Ser. No. 11/268,759, owned by the owners of the present invention, and hereby fully incorporated herein by reference.

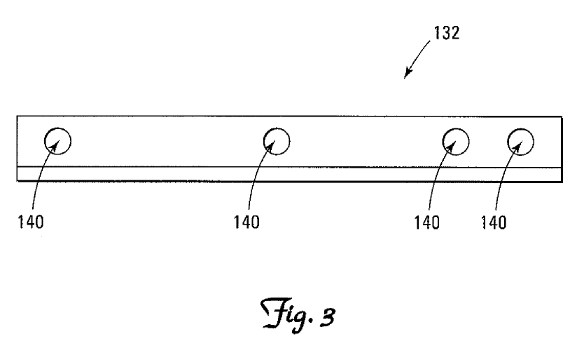

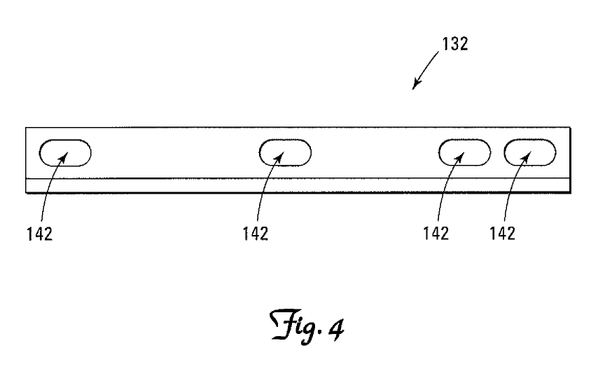

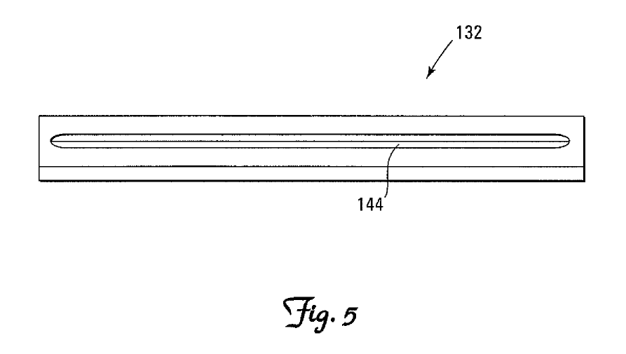

Various embodiments of track 132 of hinge assembly 106 are depicted in FIGS. 3-5. Referring to FIG. 3, track 132 defines substantially circular apertures 140 in an example embodiment. Apertures 140 may, for example, be anchoring holes adapted to receive fastening members such as screws or nails for mounting sash lifter 108 to window frame 102. Apertures 140 may also be adapted to directly receive sash lifter 108. Referring to FIG. 4, track 132 defines elongated slots 142 in another embodiment. Like apertures 140, slots 142 may be adapted to receive fastening members such as screws or nails for mounting sash lifter 108 to window frame 102. Referring to FIG. 5, track 132 defines mating structure 144 adapted to directly receive sash lifter 108. Structure 144 may, for example, be a groove or a raised surface. Generally, mating structure 144 is adapted to mate with a complementary structure of sash lifter 108.

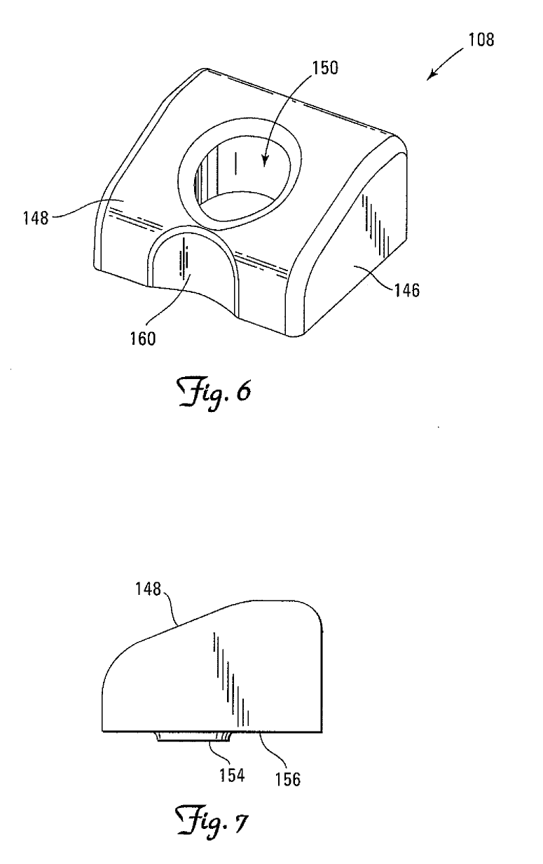

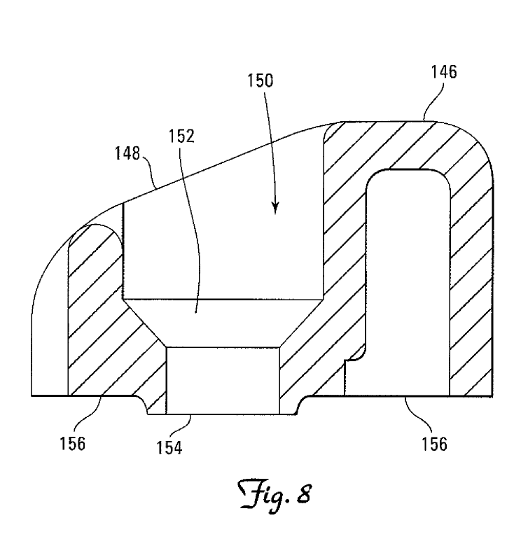

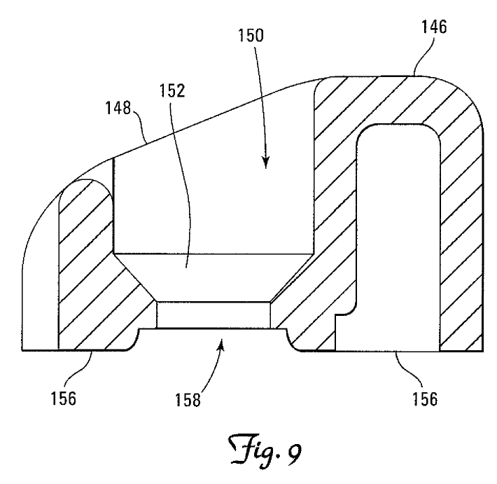

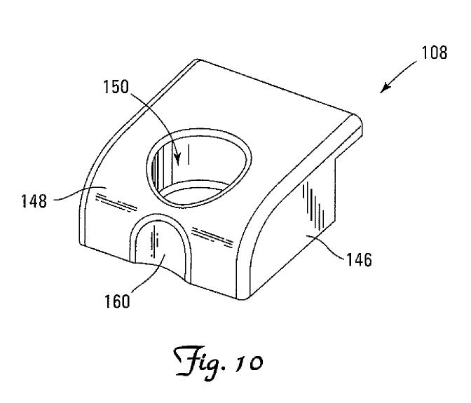

Referring to FIGS. 6-10, sash lifter 108 includes body 146. Body 146 generally has an arcuate top surface 148. Sash lifter 108 may further define channel 150. Channel 150 generally extends through body 146 and is adapted for receiving fastening member 152. Referring to FIGS. 7-8, body 146 may also include track-engaging protrusion 154 extending from bottom surface 156 in an example embodiment. Track-engaging protrusion 154 generally provides positive engagement with track 132 at anchoring hole 26. Referring to FIG. 9, body may include track-engaging recess 158 in an alternative embodiment. Track-engaging recess 158 generally provides positive engagement with mating structure 144 of track 132.

Referring to FIG. 11, sash lifter 108 may be mounted directly onto track 132 for ease of use and assembly. A conventional track screw or other fastening member may be placed through channel 150 into aperture 140 or slot 142 to secure sash lifter 108 to track 132. Mounting sash lifter 108 through aperture 140 or slot 142 on track 132 enables level and secure positioning of sash lifter 108 on track 132. In embodiments of track 132 in which mating structure 144 is a groove, sash lifter 108 can be secured to track 132 by positioning track-engaging structure 154 into groove. In embodiments of track in which mating structure 144 is a raised surface, sash lifter 108 can be secured to track 132 by positioning the raised surface of mating structure 144 into track-engaging recess 158 of sash 108.

Sash lifter 108 is generally a single piece without any moving parts that may be mounted directly on track 132 such that sash lifter 108 buttresses window sash 104 to prevent sash sag. Thus, once mounted on track 132, sash lifter 108 remains in place keeping the window assembly 100 square and need not be adjusted like conventional hinge assemblies. Sash lifter 108 may also include notch 160 in arcuate top surface 148.

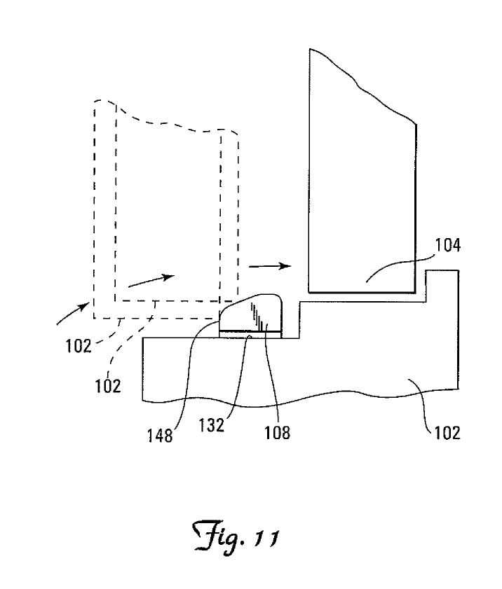

Referring to FIG. 10, an alternate embodiment of sash lifter 108 is depicted. In this embodiment, sash lifter 108 may function as a forced-entry resistance block in an FER system. As depicted in FIG. 10, sash lifter 108 may include tail portion 162. Sash lifters 30 may be mounted on upper horizontal frame member 114 and lower horizontal frame member 116 opposite hinges 106a, 106b, as depicted in FIG. 2. Tail portion 162 fits into gap 164 between window frame 102 and window sash 104. In this position, sash lifters 108 inhibit vertical motion of window sash 104 within window frame 102. As a consequence, sash lifters 108 can impede an intruder from defeating the locking mechanism of the window, which is typically provided on the side of the window opposite the hinges, by moving window sash 104 vertically within window frame 102.

In operation, as depicted in FIG. 11, as sash 104 is closed, sash 104 rides up on arcuate top surface 148 and is smoothly lifted into position in the window frame 102. It will be appreciated that the position of sash lifter 108 on track 132 promotes engagement of the sash lifter 108 with the window sash 104 over a relatively greater range of motion of window sash 104.

Sash lifter 108 may be used as an FER block in wood, aluminum or plastic extrusion windows. In the FER block embodiment, track-engaging structure 154 may collapse into a groove in the frame to allow flat mounting on the surface of vinyl or aluminum frames. In wood frames, track engaging structure 154 may penetrate the wood allowing a flat mount. Alternatively, the lip may be made sufficiently dimensionally thin or of crushable or frangible material so as to be crushed or fractured from sash lifter 108 when sash lifter 108 is fastened to a surface without an aperture, thereby enabling level and secure attachment of the fastener to nearly any planar surface.

In yet another embodiment, sash lifter 108 may be used as a shipping block. However, unlike conventional shipping blocks which are designed to be removed prior to installation, sash lifter 108 may remain in place after the window assembly is installed to function as sash lifter 108.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What is claimed is:

1. A casement window system comprising:
a window frame;
a window sash;
a hinge assembly coupling the window sash to the window frame, the hinge assembly including a track portion on the window frame, the track portion defining at least one aperture; and
a sash lifter comprising:
a body with a first side presenting a sash positioning surface and a generally opposing second side presenting a frame mounting surface, the body defining an opening for receiving a fastening member; and
a protrusion extending outwardly from the second side, the protrusion mating with the aperture on the track portion of the hinge assembly to locate the sash lifter on the track portion.

2. The casement window system of claim 1, wherein the body presents a distal end and a proximal end, the sash positioning surface sloping generally upward from the distal end to the proximal end.

3. The casement window system of claim 2, wherein the sash positioning surface defines a substantially arcuate region between the distal and proximal ends.

4. The casement window system of claim 2, wherein the sash positioning surface defines a substantially planar region between the distal and proximal ends.

5. The casement window system of claim 3, wherein the sash positioning surface further defines a substantially planar region between distal and proximal ends, the substantially arcuate region being located generally distally and the substantially planar region being located generally proximally.

6. The casement window system of claim 1, wherein the sash lifter substantially prevents lateral movement of the window sash within the window frame.

7. The casement window system of claim 2, wherein the body of the sash lifter further defines a notch at the distal end.

8. The casement window system of claim 1, wherein the protrusion can be snap-fit into the aperture.

9 The casement window system of claim 1 wherein the aperture is elongate and the protrusion is slidable in the aperture.

10. A casement window system comprising:
a window frame;
a window sash in the window frame defining a gap therebetween;
a hinge assembly coupling the window sash to the window frame; and
a sash lifter on the window frame, the sash lifter comprising:
a body presenting a sash positioning surface and defining an opening for receiving a fastening member to fasten the sash lifter to the frame; and
a tail portion extending outwardly from the body, the tail portion extending into the gap defined between the window frame and the window sash

11. The casement window system of claim 10, wherein the body presents a distal end and a proximal end, the sash positioning surface sloping generally upward from the distal end to the proximal end.

12. The casement window system of claim 11, wherein the sash positioning surface defines a substantially arcuate region between the distal and proximal ends.

13. The casement window system of claim 11, wherein the sash positioning surface defines a substantially planar region between the distal and proximal ends.

14. The casement window system of claim 13, wherein the sash positioning surface further defines a substantially planar region between distal and proximal ends, the substantially arcuate region being located generally distally and the substantially planar region being located generally proximally.

15. The casement window system of claim 10, wherein the sash lifter substantially prevents lateral movement of the window sash within the window frame.

16. The casement window system of claim 10, wherein the tail portion inhibits vertical shifting of the window sash within the window frame.

17. A casement window system comprising:
a window frame;
a window sash;
a hinge assembly coupling the window sash to the window frame, the hinge assembly including a track portion on the window frame; and
a sash lifter comprising:
a body with a first side presenting a sash positioning surface and a generally opposing second side presenting a frame mounting surface, the body defining an opening for receiving a fastening member; and
means for locating the sash lifter on the window frame.

18. The casement window system of claim 17, wherein the means for locating the sash lifter on the window frame comprises a protrusion extending outwardly from the frame mounting surface.

19. The casement window system of claim 18, wherein the window frame is made from wood, the protrusion being adapted to facilitate penetration of the wood.

20. The casement window system of claim 18, wherein the window frame defines a groove and is made from a non-wood material, the protrusion being adapted to collapse into the groove.

21. The casement window system of claim 18, wherein the track portion of the hinge assembly defines an aperture, and the protrusion mates with the aperture to locate the sash lifter on the track portion.
